(19) United States
(12) Patent Application Publication
(10) Pub. No.: US 2005/0046891 A1
(43) Pub. Date: Mar. 3, 2005

(54) Systems and methods for controlling a manufacturing system

(76) Inventors: Vladimir Pavlov, San Diego, CA (US); Srinivas Bhakthavatsalam, San Diego, CA (US); Baljit S. Toor, Escondido, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/653,809

(22) Filed: Sep. 3, 2003

(51) Int. Cl. G06K 1/00

(52) U.S. Cl. 358/1.15

(57) ABSTRACT

Disclosed are systems and methods for controlling a manufacturing system. In one embodiment, a system and method pertains to intercepting a call requesting presentation of a standard user interface, collecting data that defines how to modify the user interface, and facilitating presentation of a modified user interface that has been modified in relation to the collected data.

### BACKGROUND

Various product manufacturers have a need to print on their products. For example, compact disc (CD) and digital video-disc (DVD) manufacturers typically print information, such as text and graphics, on their discs during the manufacturing process.

Instead of designing or hiring another to design a specialized printing device that is uniquely adapted for their particular manufacturing equipment, many manufacturers would rather leverage the printing functionality of a standard “office-type” printing device, such as a desktop ink jet printer, that is configured to print on thin sheet material, such as pieces of paper. In several cases, the manufacturer may be able to incorporate the print mechanism of such a standard printing device into their manufacturing line, to thereby save the time and costs associated with designing, or having another design, a specialized printing device. In such a case, the manufacturer need only integrate the existing print mechanism into the manufacturing system.

Such integration of an existing print mechanism comprises physically integrating the mechanism into the manufacturing line by, for instance, providing any conveying devices (e.g., robotics) that are necessary to correctly position the product to be printed on (e.g., CD or DVD) and deliver that product to the next manufacturing station after such printing. In addition to such physical integration, an appropriate control system must also be integrated into the manufacturing system to control operation of the print mechanism and coordinate that operation with other equipment of the system. Typically, such print mechanisms are controlled using a printer driver, which comprises software that is configured to execute on a computer and transmit commands to the print mechanism. Although such a printer driver can be downloaded onto a computer system that is used to control the manufacturing system, the manufacturer may need or desire to customize the driver (including the driver user interface) so as to accommodate a functionality that is particular to the manufacturing process. For instance, the manufacturing system may include other equipment whose operation must be synchronized with that of the print mechanism. Therefore, it may be necessary or desirable to control that other equipment using the printer driver. In addition or alternatively, the manufacturer may simply wish to change the appearance of the driver user interface to harmonize the interface with others of the manufacturing control system.

Such customization of the printer driver can be effected by the print mechanism provider or by the manufacturer who is seeking to integrate the print mechanism into a manufacturing system. Unfortunately, there are obstacles to such customization for both parties. As for the print mechanism provider, it is difficult for the provider to modify their printer driver to suit each specialized application of each manufacturer. First, there are high costs associated with developing such a customized printer driver. Moreover, it is difficult for the print mechanism provider to customize the printer driver given that, as an outsider, the provider normally does not understand the manufacturing system in which the print mechanism is to be used as well as the manufacturer. Even if the provider is able to develop a customized printer driver, the provider may then need to provide time-consuming and costly support to the manufacturer each time a problem is encountered in that, having developed the customized printer driver and being the only one familiar with it, the provider may be the only party with the knowledge needed to remedy the problem.

Although the manufacturer that purchased the print mechanism may be given access to the source code of the printer driver to enable the manufacturer to effect the desired customization, most providers are hesitant to provide such access to that proprietary information. Even if the manufacturer were given such access, it is unlikely that the manufacturer would be able to easily and effectively customize it given the manufacturer's unfamiliarity with the printer driver and its operation.

From the foregoing, it can be appreciated that it would be desirable to provide a system and method for customizing a printer driver that could be implemented with relative ease by a product manufacturer.

### SUMMARY

Disclosed are systems and methods for controlling a manufacturing system. In one embodiment, a system and method pertains to intercepting a call requesting presentation of a standard user interface, collecting data that defines how to modify the user interface, and facilitating presentation of a modified user interface that has been modified in relation to the collected data.

### BRIEF DESCRIPTION OF THE DRAWINGS

The disclosed systems and methods can be better understood with reference to the following drawings. The components in the drawings are not necessarily to scale.

FIG. 1 is a schematic view of an embodiment of a manufacturing system in which a print mechanism is integrated.

FIG. 2 is a block diagram of an embodiment of a computer that implements a control system shown in FIG. 1.

FIG. 3 is a flow diagram that illustrates an embodiment of a method for controlling a manufacturing system.

FIG. 4 is a schematic view of the control system shown in FIG. 1, illustrating communications between various components of that system during the controlling of FIG. 3.

FIG. 5 is a schematic depiction of a customized user interface that may be presented to a user by the control system shown in FIG. 1.

FIG. 6 is a flow diagram that illustrates an embodiment of operation of a user interface modification system shown in FIGS. 1 and 4.

### DETAILED DESCRIPTION

As described above, it is often difficult for both print mechanism providers and product manufacturers to customize a printer driver used to control a print mechanism that has been integrated into a manufacturing system. As is discussed in the following, however, a manufacturer can be provided with tools that facilitate such customization. In particular, the manufacturer can be provided with a mechanism for intercepting communications from the printer driver to the driver user interface module to enable the manufacturer to present a modified user interface to the system operator. For instance, control features (e.g., check boxes, buttons, etc.) may be added to the user interface enable the operator to control the print mechanism in a specialized manner. Alternatively or in addition, other control features may be added to the user interface which enable the operator to control other equipment of the manufacturing system. To cite a further example, the appearance of the user interface can be modified to match a standard interface layout. As will be appreciated from the following discussion, nearly any such modification may be implemented with the tools provided to the manufacturer.

Disclosed herein are embodiments of systems and methods for controlling a manufacturing system. Although particular embodiments are disclosed, these embodiments are provided for purposes of example only to facilitate description of the disclosed systems and methods.

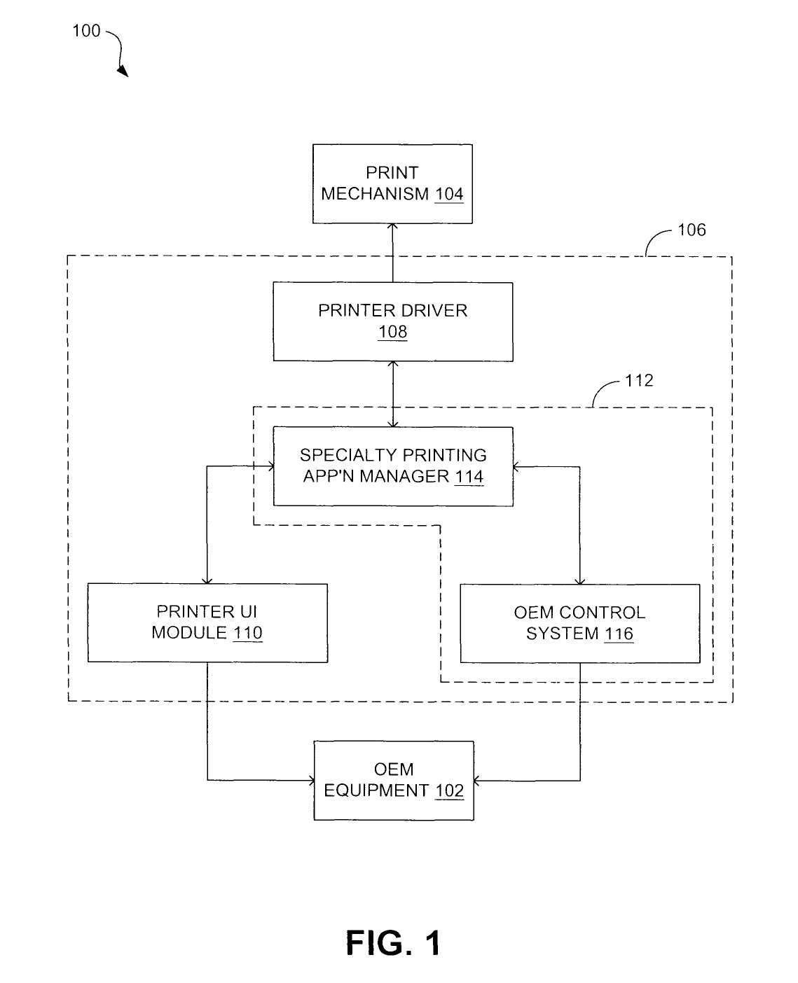

Referring now in more detail to the drawings, in which like numerals indicate corresponding parts throughout the several views, FIG. 1 illustrates a manufacturing system 100 that is configured to produce products that are to be printed on. As indicated in that figure, the system 100 comprises various system equipment including original equipment manufacturer (OEM) equipment 102 that is used to fabricate the subject products, and a print mechanism 104 that has been provided by an independent printing device provider and integrated into the system 100 by the OEM.

The nature and configuration of the OEM equipment 102 depends upon the products (or “equipment”) the manufacturer produces and are particular to such production. By way of example, such products may comprise compact discs (CDs) and digital video disc (DVDs), or identification (ID) cards. More generally, however, the products can comprise any product that may be printed on by the print mechanism 104. Regardless, the OEM equipment 102 may comprise one or more of conveying, cutting, laminating, digital writing, or other manipulating mechanisms.

The configuration of the print mechanism 104 likewise depends upon the particular implementation. For instance, the print mechanism 104 may comprise a laser print mechanism that is configured to fuse dry toner to the product, or may comprise an ink jet print mechanism that is configured to eject ink droplets on the product. Regardless, the print mechanism 104 comprises those components that are necessary to deliver toner/ink (wet or dry, multi-colored or monochrome) to the product in a desired pattern comprising text and/or graphics. In some embodiments, the print mechanism 104 may comprise a print mechanism from a standard “office-type” printing device that is configured to print on thin sheet material, such as pieces of paper. In such a case, the print mechanism 104 and/or the OEM equipment 102 that works in conjunction with the print mechanism 104 may need to be physically modified to adapt the print mechanism 104 for printing within the manufacturing system 100.

Further provided in the manufacturing system 100 is a control system 106 that is used to control and coordinate operation of the system equipment, including the OEM equipment 102 and the print mechanism 104. The control system 106 comprises various logic (e.g., software and/or firmware) that include various programs (or program modules). In the embodiment of FIG. 1, the control system 106 includes a printer driver 108, a printer user interface (UI) module 110, and a UI modification system 112 that, in the embodiment of FIG. 1, comprises a specialty printing application manager 114 and an OEM control system 116.

The printer driver 108 typically comprises driver software that is developed and provided by the print mechanism provider. For instance, the printer driver 108 may comprise the standard driver that is provided along with the print mechanism 104 (e.g., when the mechanism is contained in a standard printing device). The printer driver 108 comprises a program that is used to control and operate the print mechanism 104. More specifically, the printer driver 108 comprises code that acts in the capacity of a translator between a host program (e.g., control system 106) and the print mechanism 104.

The printer UI module 110 comprises the code that supports one or more UIs that are presented to the user (i.e. system operator) when the user wishes to control operation of the print mechanism 104. The one or more UIs include various features (typically graphical features presented in a computer display) that the user may select or otherwise manipulate to control the print mechanism 104. Like the printer driver 108, the printer UI module 110 may comprise a standard printer UI module that is provided with the print mechanism 104. As is discussed in greater detail below, the information presented to the user with the printer UI module 110 (and therefore the functionalities presented to the user) can be modified by the UI modification system 112 to customize control and operation of the manufacturing system 100.

As its name suggests, the UI modification system 112 operates to modify a UI that is presented to the operator to facilitate such customization. As mentioned above, such modification may comprise, for example, adding control features that enable the user to control the print mechanism 104 in a specialized manner and/or control other equipment, as well as modify the appearance of the UI presented to the user. Further modification may include “removing” control or other features from the standard printer UI (e.g., such as those that pertain to paper handling). Again, nearly any modification could be effected using the UI modification system 112.

Such modification is facilitated, at least in part, by the specialty printing application manager 114, which is configured to enable the manufacturer to modify the printer UI and, therefore, customize operation of the manufacturing system (i.e. the “specialty printing application”). As is described in greater detail below, the specialty printing application manager 114 is configured to intercept calls made by the printer driver 108 to the printer UI module 110 (e.g., upon initiation of the driver) to provide the manager with an opportunity to collect data from the OEM control system 116 that will be used by the printer UI module to implement various UI modifications. As is illustrated in FIG. 1, the specialty printing application 114 communicates with and resides between the printer UI module 110 and the OEM control system 116 so as to insulate the printer UI module 110 (as well as the printer driver 108) from the OEM control system 116.

The OEM control system 116 typically comprises various code developed by the OEM. The OEM control system 116 at least comprises code that, upon request from the specialty printing application manager 114, generates data to be provided to and implemented by the printer UI module 110 to modify the printer UI and, therefore, customize control and/or operation of the manufacturing system 100. As is discussed in greater detail below, that data can comprise pointers to data and/or code, within or external to the OEM control system 116, that supports features to be presented to the user with a UI. With such operation, the UI modification system 112 dynamically substitutes a modified UI for the standard printer UI that the printer UI module 110 is configured to present by default.

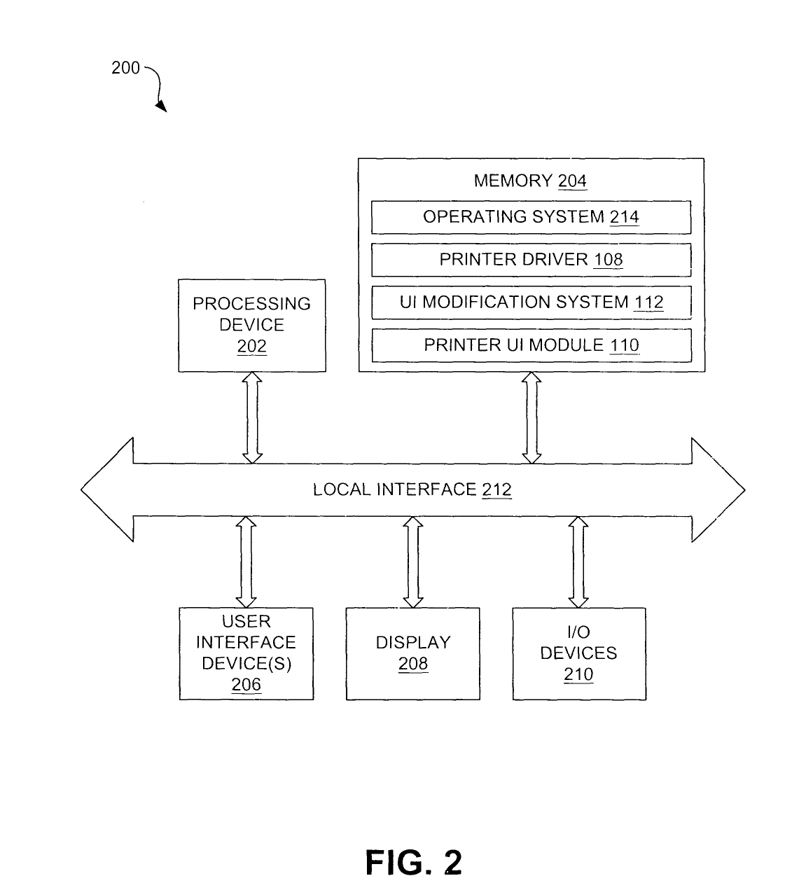

FIG. 2 is a block diagram which illustrates an example architecture for a computer 200 that implements (i.e. executes) the control system 106 shown in FIG. 1. As indicated in FIG. 2, the computer 200 comprises a processing device 202, memory 204, at least one user interface device 206, a display 208, and at least one input/output I/O device 210, each of which is connected to a local interface 212.

The processing device 202 can include a central processing unit (CPU) or an auxiliary processor among several processors associated with the computer 200, or a semiconductor-based microprocessor (in the form of a microchip). The memory 204 includes any one of or a combination of volatile memory elements (e.g., RAM) and nonvolatile memory elements (e.g., read only memory (ROM), hard disk, tape, etc.).

The user interface device(s) 206 comprise the physical components with which a user (i.e. operator) interacts with the computer 200, such as a keyboard and mouse. The display 208 comprises a device with which visual information is presented to the user, such as a cathode ray tube (CRT) or liquid crystal display (LCD) monitor.

With further reference to FIG. 2, the one or more I/O devices 210 are adapted to facilitate communication with other devices. By way of example, the I/O devices 210 may include one or more of a universal serial bus (USB), a Firewire, or a small computer system interface (SCSI) connection component and/or network communication components such as a modem or a network card.

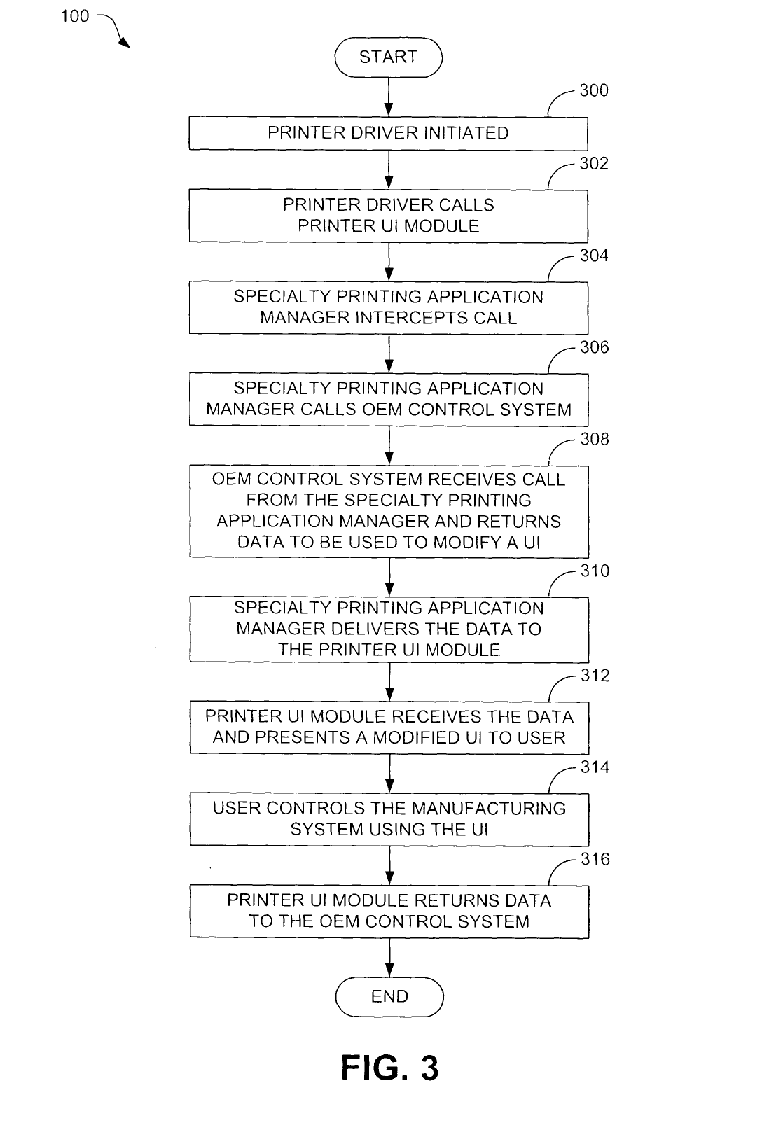

The memory 204 comprises various programs including an operating system 214 that controls the execution of other programs and provides scheduling, input-output control, file and data management, memory management, and communication control and related services. In addition to the operating system 214, the memory 204 comprises the printer driver 108, UI modification system 112, and the printer UI module 110 identified above in relation to FIG. 1. Operation of those components is described in relation to FIGS. 3-6.

Various programs (i.e., logic) have been described herein. These programs can be stored on any computer-readable medium for use by or in connection with any computer-related system or method. In the context of this document, a computer-readable medium is an electronic, magnetic, optical, or other physical device or means that contains or stores a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

Example systems having been described above, operation of the systems will now be discussed. In the discussions that follow, flow diagrams are provided. Process steps or blocks in these flow diagrams may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

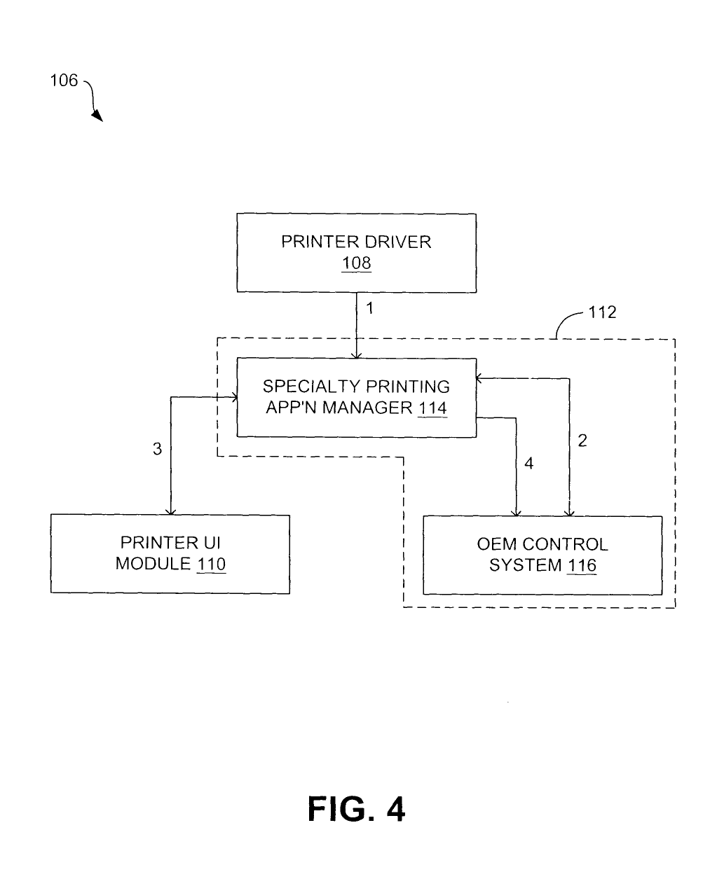

FIG. 3 provides an overview of an embodiment of operation of the manufacturing system 100 of FIG. 1. Beginning with block 300 of FIG. 3, the printer driver 108 is initiated. Such initiation can occur, for example, upon initiation of the manufacturing system 100, or specific initiation of a printing process that is to be performed during operation of the manufacturing system. Alternatively, such initiation can occur when the user (e.g., system operator) selects an option (e.g., an onscreen icon) to view and/or change print mechanism (or other equipment) settings. Irrespective of the manner in which the printer driver 108 is initiated, the driver then calls the printer UI module 110 (FIG. 1), as indicated in block 302, with the intention of causing the printer UI module 110 to generate the standard printer UI. This call is represented by arrow 1 in FIG. 4.

The call made by the printer driver 108 does not reach the printer UI module 110, however. Instead, as indicated in block 304 of FIG. 3 and illustrated in FIG. 4, the specialty printing application manager 114 intercepts the call. This interception is possible in that the specialty printing application manager 114 exercises control over the entire control system 106 and therefore “sees” all communications issued by each control system component.

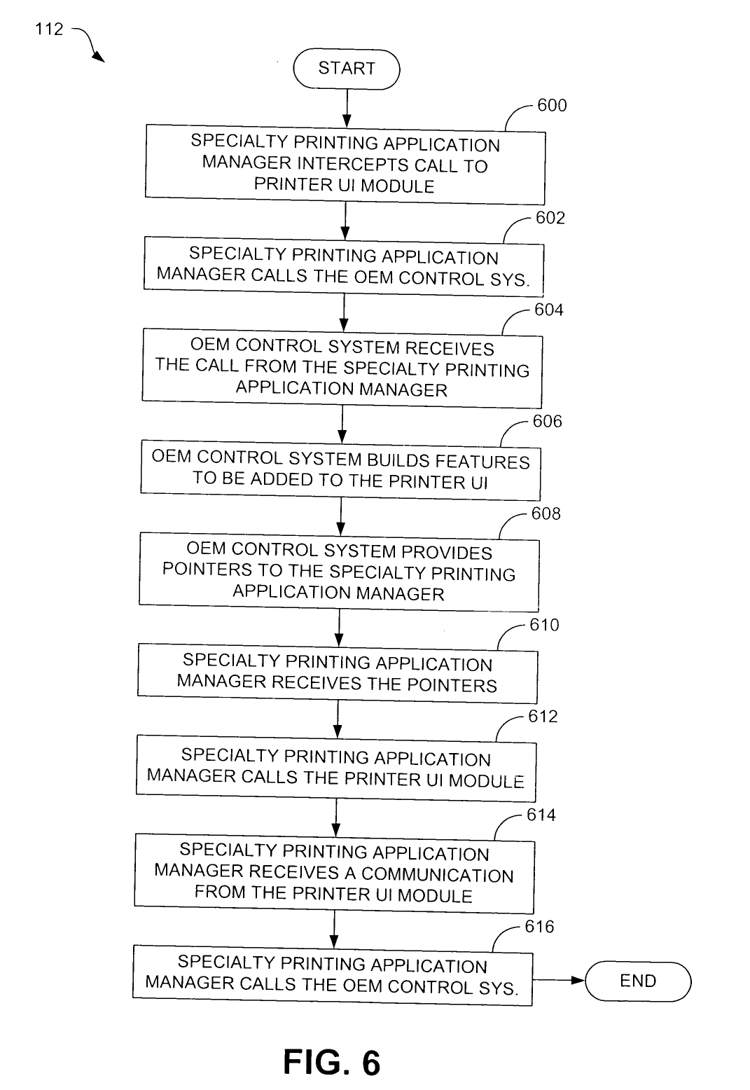

After intercepting the call made by the printer driver 108, the specialty printing application manager 114 calls the OEM control system 116, as indicated in block 306 of FIG. 3. This call is represented by arrow 2 in FIG. 4. The nature of this call is described in greater detail in relation to FIG. 6. Generally speaking, however, the call made by the specialty printing application manager 114 is equivalent to a request for data that will be used to present a modified UI to the user.

Next, with reference to block 308 of FIG. 3, the OEM control system 116 receives the call from the specialty printing application manager 114 and returns data to be used to modify the printer UI. This communication is also represented by arrow 2 in FIG. 4. As is described below, the data provided by the OEM control system 116 may comprise one or more pointers that identify the location of data and/or executable code that comprise part of the OEM control system 116. By way of example, the data may support visual features that are to be presented in the modified UI, and the executable code may comprise instructions associated with the presented features that are used to control operation of a piece of system equipment (e.g., print mechanism 104 and/or OEM equipment 102).

Referring now to block 310, the specialty printing application manager 114 calls the printer UI module 110 to deliver the data obtained from the OEM control system 116. This communication is represented by arrow 3 in FIG. 4. The printer UI module 110 receives the data provided by the OEM control system 116 and, as a consequence, presents a modified UI to the user, as indicated in block 312 of FIG. 3. If, as described above, the data provided by the OEM control system 116 included pointers to data and/or code, the printer UI module 110 can have built the modified UI with reference to that data and/or code. For instance, the printer UI module 110 can have retrieved graphical data describing additional features (e.g., check boxes, buttons, etc.) to add to the standard printer UI that are not normally presented in that printer UI.

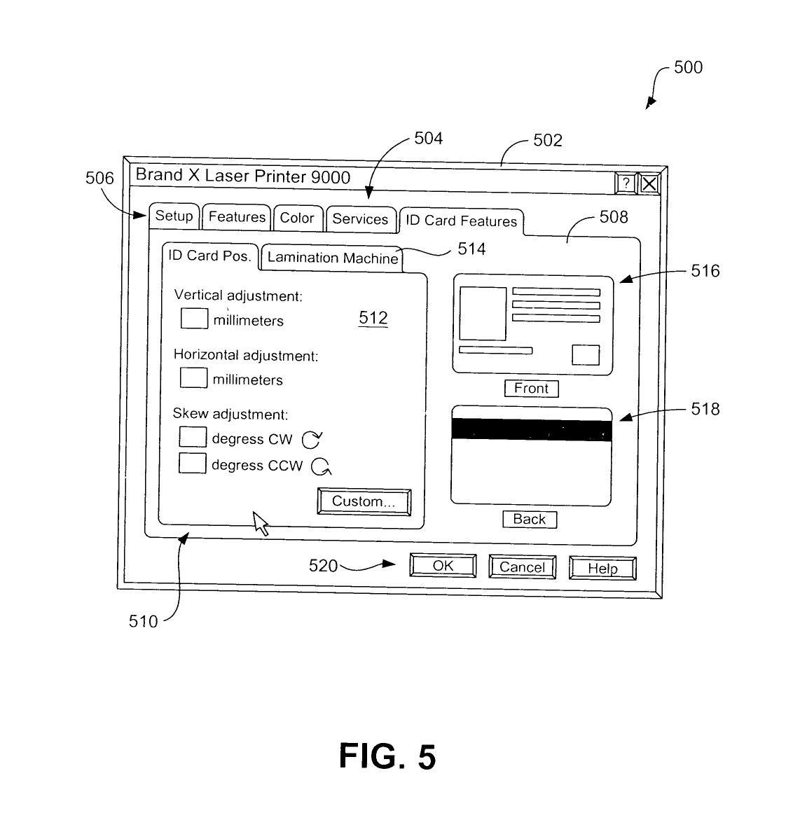

FIG. 5 provides an example modified UI 500 that can be presented to the user. In the example of FIG. 5, the OEM manufactures ID cards and therefore has a need to customize the standard printer UI to support functionalities pertinent to ID card production. As shown in FIG. 5, the modified UI 500 comprises a window 502 in which a plurality of interface pages 504 are provided that may be accessed by selecting a tab 506 associated with the desired page. The interface pages 504 may include several default pages that are presented in the standard printer UI such as “Setup,” “Features,” “Color,” and “Services” pages. However, the UI 500 has been modified to further include an “ID Card Features” page 508 that comprises options that are directly pertinent to printing on or otherwise manipulating ID cards.

In the example of FIG. 5, the “ID Card Features” page 508 includes two tabbed sub-pages 510 including an “ID Card Pos.” and sub-page 512 that presents options to the user that are relevant to adjusting the position of the ID card(s) prior to printing. Those options include a vertical adjustment, a horizontal adjustment, and two skew adjustments (clockwise and counterclockwise). Furthermore, the sub-page 512 also includes a “Custom . . . ” option that leads to other options regarding ID card positioning. As is further shown in FIG. 5, a “Lamination Machine” sub-page 514 is also presented to the user that provides control options for an ID card lamination machine (i.e. part of the OEM equipment 102) that is downstream of the print mechanism 104 and whose operation may need to be synchronized with that of the print mechanism.

In addition to the sub-pages 510, the “ID Card Features” page 508 further includes representations of the front and back sides 516 and 518 of an ID card to indicate to the user the type of ID card for which the system 100 is currently configured. Beyond the interface pages 504 are various buttons 520 including an “OK” button that is used to enter the various options that were selected (or already had been selected), a “Cancel” button that is used to exit the UI 500 and not enter any new selections that may have been made, and a “Help” button that is used to provide support to the user as to how to properly use the modified UI 500.

From the above-provided description of modified UI 500, it can be appreciated that various types of UI modifications or customizations can be effected by delivering the OEM control system 116 (FIG. 1) data to the printer UI module 110. For example, control features, in the form of options presented in the “ID Card Pos.” sub-page 512, were added to the printer UI that enable the user to control the print mechanism 104 in a specialized manner. In addition, other control features, in the form of options presented in the “Lamination Machine” sub-page 514, were added to the printer UI that enable the user to control operation of other equipment (i.e. OEM equipment 102) of the manufacturing system 100. Moreover, the appearance of the printer UI was modified by the addition of the ID card representations 516, 518.

Returning to FIG. 3, the user next controls the manufacturing system 100 in some manner using the modified UI, as indicated in block 314. With reference back to FIG. 5, such control may be exercised by the user entering one or more selections in the “ID Card Features” page 508 and selecting “OK.” Such an action may then cause the printer UI module 110 to execute one or more code segments identified by one or more pointers associated with the given selection(s), or may simply cause an instruction to execute such code segments(s) to be provided to the OEM control system 116. By way of example, execution of the one or more code segments may cause a specific action to be taken by system equipment (e.g., print mechanism 104 and/or OEM equipment 102). In the case in which the printer UI module 110 merely sends an instruction to the OEM control system 116, a communication is first sent to the specialty printing application manager 114 (arrow 3 in FIG. 4), and is then delivered by the specialty printing application manager to the OEM control system 116 (arrow 4 in FIG. 4). Regardless, the printer UI module 110 returns data to the OEM control system 116 via the specialty printing application manager 114, as indicated in block 316. At this point, flow for the given system control session is terminated.

FIG. 6 describes an embodiment of operation of the UI modification system 112 shown in FIGS. 1 and 4 in facilitating UI modification such as that described in relation to FIG. 3. Beginning with block 600 of FIG. 6, the specialty printing application manager 114 intercepts a call sent by the printer driver 108 and directed at the printer UI module 110. As noted above, this interception is possible in that the specialty printing application manager 114 exercises control over the entire control system 106 and therefore “sees” all communications issued by each control system component.

The call to the printer UI module 110 results from initiation of the printer driver 108. Such initiation may occur when the printer driver 108 is called from another application (e.g., OEM application), or may occur when the printer driver 108 is called by the operating system (e.g., operating system 214, FIG. 2), for example due to a user selection made in a printer folder. For purposes of the following discussion, however, it is assumed that the printer driver 108 has been called from another application. By way of example, the call comprises a call to a “UIDisplaySetupDialog ( )” function of the printer UI module 110. The signature of that function may be defined as follows:

| | | |
|---|---|---|
| UIDisplaySetupDialogs | (HWND | hWnd, |
| | HINSTANCE | hInstance, |
| | DJDEVMODE | *pRawDevmode); |

| | |
|---|---|
| where: | |
| | hWnd = a handle to a window, |
| | hInstance = a handle to an “instance” (the UI module), and |
| | *pRawDevmode = a pointer to the “raw” DEVMODE. |

Once the call has been intercepted, the specialty printing application manager 114 calls the OEM control system 116, as indicated in block 602. This call may be designated a “preCall” in that it is made prior to a UI being presented to a user (i.e. system operator). By way of example, the preCall comprises a call to a “preUIDisplaySetupDialogs ( )” function of the OEM control system 116. The signature of that function may be defined as follows:

| | | |
|---|---|---|
| preUIDisplaySetupDialogs | (HWND | hWnd, |
| | HINSTANCE | hInstance, |
| | LPVOID | |

pOemDevmodeStruct,

| | |
|---|---|
| int | *iNumOemPages, |
| C_UICommonPropPage | **pOemPages); |

| | |
|---|---|
| where: | |
| | hWnd = a handle to a window, |
| | hInstance = a handle to an “instance” (OEM control system), |
| | pOemDevmodeStruct = a pointer to the OEM DEVMODE |
| | structure, |
| | *iNumOemPages = the number of new OEM created Property |
| | Pages/Sheets, and |
| | **pOemPages = a pointer to the OEM Property Pages/Sheets. |

Through the preCall, the specialty printing application manager 114 provides a set of functions to the OEM control system 116 that the OEM control system can use to define the features (such as property pages) to be added to the printer UI, as well as default features to be “removed” from (i.e. disabled in) the printer UI.

Next, with reference to block 604, the OEM control system 116 receives the preCall from the specialty printing application manager 114. From the functions provided by the specialty printing application manager 114, the OEM control system 116 can build the features (e.g., property pages) that are to be added to the printer UI, as indicated in block 606, so as to facilitate modification of that UI. Those features are constructed by identifying various pointers to data and/or executable code that is pertinent to presenting and supporting the modified UI. By way of example, the pointers may identify locations of a dynamic link library (DLL) of the OEM control system 116 that may be dynamically accessed by the printer UI module 110 when a UI is to be presented to the user.

At this point, the OEM control system 116 provides a set of pointers to the specialty printing application manager 114, as indicated in block 608. Those pointers are received by the specialty printing application manager 114, as indicated in block 610, and the specialty printing application manager then calls the printer UI module 110, as indicated in block 612. By way of example, that call comprises a call to a “UIAddOemPropPages ( )” function of the printer UI module 110. The signature of that function may be defined as follows:

| | | |
|---|---|---|
| UIAddOemPropPages | (HWND | hWnd, |
| | HINSTANCE | hInstance, |
| | DJDEVMODE | *pRawDevmode, |
| | int | iNumPages, |
| | C_UICommonPropPage | ** pOemPages); |

| | |
|---|---|
| where: | |
| | hWnd = a handle to a window, |
| | hInstance = a handle to an “instance” (the UI module), |
| | *pRawDevmode = a pointer to the “raw” DEVMODE structure |

(Public and Private),

iNumPages = the number of new OEM Property Pages/
Sheets, and
**pOemPages = a pointer to an array of OEM Property
Pages/Sheets.

Through the call to the printer UI module 110, the various pointers identified by the OEM control system 116 are passed to the printer UI module so that the module has the information needed to dynamically modify the printer UI.

At this point, the printer UI module 110 presents the modified UI to the user, as discussed in relation to FIGS. 3-5. Therefore, various information and/or options are provided to the user, including that which may not be normally provided in the standard printer UI. For instance, options may be provided as to controlling the print mechanism 104 in a specialized manner to achieve a printing result specific to the manufactured products, and/or controlling other system equipment (e.g., OEM equipment 102). Once the user has made all of the desired selections (e.g., on various interface pages presented to the user), the user can then enter the selections, for example by selecting an “OK” button or equivalent.

What occurs next depends upon the particular control system implementation. More particularly, operation at this point depends upon what the pointers that were provided to the printer UI module 110 identify. For instance, if the pointers merely point to data and/or code used to support visual features of the modified UI (e.g., check boxes, buttons, etc.) and register their selection, the printer UI module 110 may just identify the selection(s) made by the user and convey those selections to the OEM control system 116 for implementation. If, on the other hand, the pointers further identify code that is used to implement the selections (e.g., drive a piece of OEM equipment), entry of a selection may cause the printer UI module 110 to communicate with one or more system components other than the print mechanism 104. Accordingly, customization may involve modifying the printer UI module 110 to directly control components other than the print mechanism 104.

Irrespective of whether the printer UI module 110 directly controls such other components, the printer UI module sends a communication to the specialty printing application manager 114 such that, as indicated in block 614, a communication is received by the specialty printing application manager. This communication may comprise instructions to the OEM control system 116 to implement selections that have been entered by the user, or may merely comprise notification as to what selections have been made (e.g., in case further action is required by the OEM control system in relation to those selections). At this point, the specialty printing application manager 114 again calls the OEM control system 116, as indicated in block 616. This call may be designated a “postCall” in that it is made after the modified UI has been presented to the user. By way of example, the postCall comprises a call to a “postUIDisplaySetupDialogs ( )” function of the OEM control system 116. The signature of that function may be defined as follows:

| | | |
|---|---|---|
| postUIDisplaySetupDialogs | (HWND | hWnd, |
| | HINSTANCE | hInstance, |
| | LPVOID | |
| pOemDevmodeStruct, | | |
| | int | *iNumOemPages, |
| | C_UICommonPropPage | **pOemPages, |
| | int | vRet); |

| | |
|---|---|
| where: | |
| | hWnd = a handle to a window, |
| | hInstance = a handle to an “instance” (the OEM control system), |
| | pOemDevmodeStruct = a pointer to the OEM DEVMODE |
| | structure, |
| | *iNumOemPages = the number of new OEM created Property |
| | Pages/Sheets, |
| | **pOemPages = a pointer to the OEM Property Pages/ |
| | Sheets, and |
| | vRet = a return value coming from OEM control system. |

1. A method for controlling a manufacturing system, the method comprising:
intercepting a call requesting presentation of a standard user interface;
collecting data that defines how to modify the user interface; and
facilitating presentation of a modified user interface that has been modified in relation to the collected data.

2. The method of claim 1, wherein intercepting a call comprises intercepting a call to a printer user interface module.

3. The method of claim 1, wherein collecting data comprises collecting data from a manufacturer control system.

4. The method of claim 3, wherein collecting data from a manufacturer control system comprises calling the manufacturer control system.

5. The method of claim 4, wherein calling the manufacturer control system comprises providing a set of functions to the manufacturer control system that the control system can use to define features that are to be added to the standard user interface.

6. The method of claim 5, wherein facilitating presentation of a modified user interface comprises receiving data that identifies at least one of data and code that is pertinent to supporting the modified user interface.

7. The method of claim 6, wherein facilitating presentation of a modified user interface comprises providing the received data to a printer user interface module.

8. The method of claim 7, wherein providing the received data comprises calling the printer user interface module to provide a set of functions to the printer user interface module that identify at least one of data and code that can be used to present the modified user interface to the user.

9. The method of claim 1, wherein facilitating presentation of a modified user interface comprises modifying the standard user interface by at least one of adding control features to the standard user interface that enable the user to control a print mechanism in a specialized manner, adding control features to the standard user interface that enable the user to control operation other system equipment, and modifying the appearance of the standard user interface.

10. The method of claim 1, further comprising receiving a selection entered by a user with the modified user interface and controlling system equipment in view of the entered selection.

11. The method of claim 10, wherein controlling system equipment comprises controlling equipment other than a print mechanism with the modified user interface.

12. A control system for controlling a manufacturing system, the control system comprising:
means for intercepting a call requesting display of a standard user interface;
means for collecting data that can be used to modify the standard user interface; and
means for generating a modified user interface.

13. The system of claim 12, wherein the means for collecting data comprise means for providing a set of functions that can be used to define features that are to be modified or added to the standard user interface.

14. The system of claim 12, wherein the means for collecting data comprise means for receiving pointers to at least one of data and code that is pertinent to modifying the standard user interface.

15. The system of claim 12, wherein the means for collecting data comprise means for providing the collected data to a printer user interface module.

16. The system of claim 15, wherein the means for providing the collected data comprise means for providing a set of functions that identify at least one of data and code that can be used to modify the standard user interface.

17. The system of claim 16, wherein the means for providing a set of functions comprise means for providing a set of functions that identify the location of at least one of data and code that can be used to dynamically modify the standard user interface.

18. The system of claim 12, wherein the means for generating a modified user interface comprise means for at least one of adding control features to the standard user interface that enable the user to control a print mechanism in a specialized manner, adding control features to the standard user interface that enable the user to control operation other system equipment, and modifying the appearance of the standard user interface.

19. The system of claim 12, further comprising means for receiving a selection entered by a user with the modified user interface and means for controlling system equipment in view of the entered selection.

20. A control system stored on a computer-readable medium, the system comprising:
logic configured to intercept a calls made by a printer driver requesting display of a standard user interface;
logic configured to request data that can be used to modify the standard user interface;
logic configured to provide the requested data to a printer user interface module; and
logic configured to generate a modified user interface using the provided data.

21. The system of claim 20, wherein the logic configured to request data comprises logic configured to provide a set of functions that can be used to define features that are to be modified or added to the standard user interface.

22. The system of claim 20, wherein the logic configured to request data comprises logic configured to request pointers that identify at least one of data and code that is pertinent to modifying the standard user interface.

23. The system of claim 20, wherein the logic configured to provide the requested data comprises logic configured to provide a set of functions that identify at least one of data and code that can be used to modify the standard user interface.

24. The system of claim 20, wherein the logic configured to provide the requested data comprises logic configured to provide pointers that identify the location of at least one of data and code that can be used to dynamically modify the standard user interface.

25. The system of claim 20, wherein the logic configured to generate a modified user interface comprise logic configured to at least one of add control features to the standard user interface that enable the user to control a print mechanism in a specialized manner, add control features to the standard user interface that enable the user to control operation other system equipment, and modify the appearance of the standard user interface.

26. The system of claim 20, further comprising logic configured to receive a selection entered by a user with the modified user interface and logic configured to control system equipment in view of the entered selection.

27. A user interface modification system, comprising:
a specialty printing application manager that is configured to intercept a calls made by a printer driver requesting display of a standard user interface and to request data that can be used to modify a standard user interface; and
a manufacturer control system that is configured to provide data that can be used to modify the standard user interface.

28. The system of claim 27, wherein the specialty printing application manager is configured to provide a set of functions to the manufacturer control system that can be used to define features that are to be modified or added to the standard user interface.

29. The system of claim 27, wherein the specialty printing application manager is further configured to provide the requested data to a printer user interface module.

30. The system of claim 29, wherein the specialty printing application manager is configured to provide a set of functions to the printer user interface module that identify at least one of data and code that can be used to modify the standard user interface.

31. The system of claim 27, wherein the manufacturer control system is configured to provide pointers to the specialty printing application manager that identify at least one of data and code that is pertinent to modifying the standard user interface.

32. A specialty printing application manager stored on a computer-readable medium, the manager comprising:
logic configured to intercept a calls made by a printer driver to a printer user interface module;
logic configured to request data that can be used to modify the standard user interface;
logic configured to receive the requested data; and
logic configured to provide the received data to a printer user interface module such that the printer user interface module can modify the standard user interface to present a modified user interface to a user.

33. The manager of claim 32, wherein the logic configured to request data comprises logic configured to provide a set of functions that can be used to define features that are to be modified or added to the standard user interface.

34. The manager of claim 32, wherein the logic configured to provide the received data comprises logic configured to provide a set of functions to the printer user interface module that identify at least one of data and code that can be used to modify the standard user interface.
